(19) United States
(12) Patent Application Publication
(10) Pub. No.: US 2007/0145914 A1
(43) Pub. Date: Jun. 28, 2007

(54) Device for driving light emitting diode

(75) Inventors: Hee Jung Hong, Seoul (KR); Haang Rhym Chu, Gyeonggi-do (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/639,222

(22) Filed: Dec. 15, 2006

(30) Foreign Application Priority Data
Dec. 22, 2005 (KR) 10-2005-0128071

(51) Int. Cl. H05B 41/36

(52) U.S. Cl. 315/291

(57) ABSTRACT

A device for driving a plurality of light emitting diodes includes a plurality of light emitting diode groups in series; a current providing unit for providing a current to the plurality of light emitting diode groups; and at least one current path controller in parallel with a corresponding one of the light emitting diode groups for turning off the corresponding one of the light emitting diode groups in accordance with a control signal.

This application claims the benefit of Korean Patent Application No. 10-2005-0128071, filed on Dec. 22, 2005, which is hereby incorporated by reference in its entirety.

### BACKGROUND OF THE INVENTION

1. Field of the invention

Embodiments of the present invention relates to a light emitting diode, and more particularly to a light emitting diode for a liquid crystal display device. Embodiments of the invention are suitable for a wide scope of applications. In particular, embodiments of the invention are suitable for driving a light emitting diode for a liquid crystal display device.

2. Description of the Related Art

Today, electronic display devices are widely used in information driven society. A variety of electronic display devices are being used in various industries. Accordingly, new types of electronic display industry have been and are being developed to satisfy the continually changing needs and requirements of the information driven society.

In general, the electronic display device transmits visual information by converting an electronic signal into an optical signal. For example, the electronic display device may include a light emitting display device, which uses light emission to display the optical signal. In another example, the electronic display device may include a light receiving display device, which uses reflection, scattering, and interference for modulating and displaying the optical signal.

The light emitting display device is called an active display device, examples of which are a cathode ray tube (CRT), a plasma display panel (PDP), an organic electro luminescent display (OELD), and a light emitting diode (LED) display. The light receiving display device is called an inactive display device, examples of which are a liquid crystal display (LCD) and an electro phoretic image display EPID.

The CRT display device has been widely used as a display device for television or computer monitor for a long-time. However, the CRT is heavy, relatively bulky, and has a high power consumption. Recent improvement in semiconductor technology lead to the development of a flat panel display device, which is thin, light and consumes relatively less power. The flat panel display devices being developed include, for example, the LCD, the PDP, and the OELD. The LCD device is of particular interest for use in small electronic devices because it is slim, and thin, and has a low power consumption.

The LCD device includes an LCD panel including a first transparent insulating substrate having a common electrode, a color filter, and a black matrix; a second transparent insulating substrate having a switching element and a pixel electrode; and a liquid crystal material having an anisotropic dielectric constant injected between the first and second transparent insulating substrates. Different voltages are applied to the pixel electrode and the common electrode of the LCD device to adjust a magnitude of an electric field of the liquid crystal material and vary a molecular arrangement of the liquid crystal material. Thus, the amount of light transmitted through the first and second transparent substrates is controlled by the voltage difference between the pixel and common electrodes to display a desired image on the LCD panel.

Because the LCD device is a light receiving display device, it cannot emit the light by itself. Accordingly, a backlight is provided in the back of the LCD panel. The backlight projects light on the LCD panel and maintains a uniform total brightness for the LCD display. The backlight may include a cold cathode fluorescent lamp (CCFL) or an external electrode fluorescent lamp (EEFL) as a light source.

However, the LED is gaining interest as a next generation light source for the backlight because of potential energy saving and quasi-permanent use compared with the CCFL and the EEFL. The use of LED as a backlight source has been so far limited to small-sized LCDs, such as in portable phones. However, recent improvement in the luminance of LEDs expands the use of LEDs as backlight source for mid-size to large LCD devices.

FIG. 1 is a circuit diagram illustrating a device for driving an LED as a light source in a backlight of an LCD device according to the related art. Referring to FIG. 1, the light source for the backlight of the LCD device includes three LED groups D₁₁ to D₁₃, D₂₁ to D₂₃, and D₃₁ to D₃₃. Constant current providing circuits 10, 20, and 30 are provided to power the respective LED groups D₁₁ to D₁₃, D₂₁ to D₂₃, and D₃₁ to D₃₃, respectively. For example, the constant current providing circuit 10 powers the first LED group D₁₁ to D₁₃ The constant current providing circuit 20 powers the second LED group D₂₁ to D₂₃. The constant current providing circuit 30 powers the third LED group D₃₁ to D₃₃. A pulse width modulation signal providing circuit 40 drives the constant current providing circuits 10, 20 and 30. The three groups of LEDs D₁₁ to D₁₃, D₂₁ to D₂₃, and D₃₁ to D₃₃ divide the backlight into three backlight regions, the luminance of which is independently controlled by the respective current providing circuits 10, 20 and 30.

In the related backlight, the constant current providing circuits 10, 20, and 30 should be provided in proportion to the number of the divided backlight regions. Thus, the number of required electronic elements for driving the light emitting diode increases with the number of backlight regions. Hence, the cost of the related art backlight also increases in relation to a number of divided backlight regions. Moreover, the wiring structure of a printed circuit board (PCB) becomes increasingly more complex in relation with the number of backlight regions.

### SUMMARY OF THE INVENTION

Accordingly, embodiments of the present invention are directed to a sputtering apparatus that substantially obviates one or more problems due to limitations and disadvantages of the related art.

An object of the present invention is to provide a device for driving a light emitting diode for a backlight of a flat panel display that requires no more than one constant-current providing circuit.

Additional features and advantages of the invention will be set forth in the description of exemplary embodiments which follows, and in part will be apparent from the description of the exemplary embodiments, or may be learned by practice of the exemplary embodiments of the invention. These and other advantages of the invention will be realized and attained by the structure particularly pointed out in the written description of the exemplary embodiments and claims hereof as well as the appended drawings.

To achieve these and other advantages and in accordance with the purpose of the present invention, as embodied and broadly described, a device for driving a plurality of light emitting diodes includes a plurality of light emitting diode groups in series; a current providing unit for providing a current to the plurality of light emitting diode groups; and at least one current path controller in parallel with a corresponding one of the light emitting diode groups for turning off the corresponding one of the light emitting diode groups in accordance with a control signal.

In another aspect, a device for driving a plurality of light emitting diode in an LCD device includes a plurality of light emitting diodes groups in parallel; a current providing unit for providing a current to the plurality of light emitting diode groups; at least one switch in series with a corresponding one of the light emitting diode groups for activating the corresponding one of the light emitting diode groups in accordance with a control signal.

In another aspect, a device for driving a plurality of light emitting diode in an LCD device includes a plurality light emitting diodes groups in parallel; a current providing unit for providing a current to the light emitting diode groups; a plurality of switches, each of which in series with a corresponding one of the light emitting diode groups for activating the corresponding one of the light emitting diode groups in accordance with a corresponding control signal.

It is to be understood that both the foregoing general description and the following detailed description are exemplary and explanatory and are intended to provide further explanation of the invention as claimed.

### BRIEF DESCRIPTION OF THE DRAWINGS

These and other objects of the invention will be apparent from the after detailed description of the embodiments of the present invention with reference to the accompanying drawings, in which:

FIG. 1 is a circuit diagram illustrating a device for driving an LED as a light source in a backlight of an LCD device according to the related art;

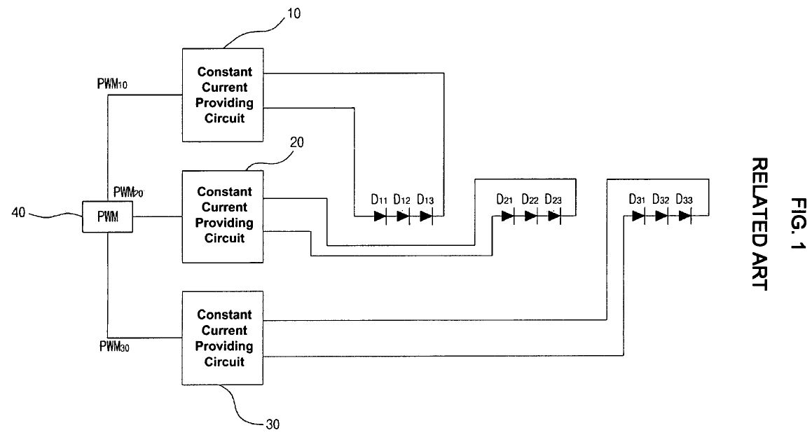

FIG. 2 is a schematic diagram of an exemplary device for driving a plurality of LEDs as a light source in a backlight of an LCD device according to an embodiment of the present invention;

FIG. 3 is a circuit diagram of an exemplary device for driving a plurality of LEDs as a light source in a backlight of an LCD device according to an embodiment of the present invention;

FIG. 4 is a graphical illustration of exemplary current path control signals for controlling the driving of LEDs of FIGS. 2 and 3 according to an embodiment of the present invention;

FIG. 5 is a schematic diagram of an exemplary device for driving a plurality of LEDs as a light source in a backlight of an LCD device according to another embodiment of the present invention;

FIG. 6 is a circuit diagram of an exemplary constant-current providing unit for the device for driving a plurality of LEDs of FIG. 5; and

FIG. 7 is a graphical illustration of exemplary group activation signals in a device for driving a light emitting diode according to anther embodiment of the present invention.

### DETAILED DESCRIPTION OF EXEMPLARY EMBODIMENTS

Preferred embodiments of the present invention will be described in a more detailed manner with reference to the drawings.

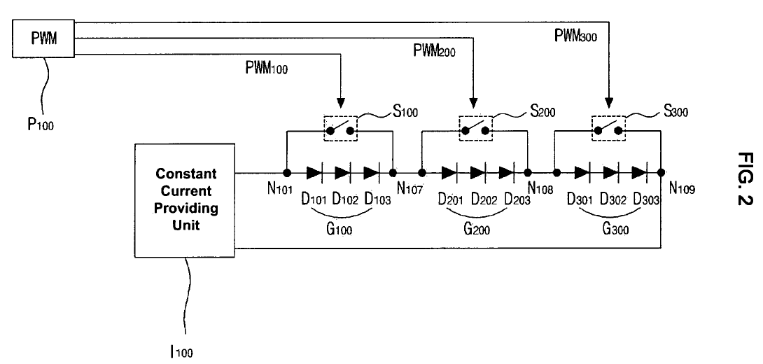

FIG. 2 is a schematic diagram of an exemplary device for driving a plurality of LEDs as a light source in a backlight of an LCD device according to an embodiment of the present invention. Referring to FIG. 2, the exemplary device for driving the LED includes a plurality of LEDs D₁₀₁ to D₁₀₃, D₂₀₁ to D₂₀₃, and D₃₀₁ to D₃₀₃ connected in series, a constant-current providing unit I₁₀₀, current path controllers S₁₀₀, S₂₀₀, and S₃₀₀, and a current path control signal providing unit P₁₀₀.

The LEDs D₁₀₁ to D₁₀₃, D₂₀₁ to D₂₀₃, and D₃₀₁ to D₃₀₃ are divided into LED groups G₁₀₀, G₂₀₀, and G₃₀₀. For example, the LED group G₁₀₀ includes light emitting D₁₀₁ to D₁₀₃ connected in series. The LED group G₂₀₀ includes LEDs D₂₀₁ to D₂₀₃ connected in series. And, the LED group G₃₀₀ includes LEDs D₃₀₁ to D₃₀₃ connected in series. Thus, the LED groups G₁₀₀, G₂₀₀, and G₃₀₀ are connected in series with each other. The constant-current providing unit I₁₀₀ provides a substantially constant current I to the LED groups G₁₀₀, G₂₀₀, and G₃₀₀.

The current path controllers S₁₀₀, S₂₀₀, and S₃₀₀ are connected in parallel with the LED groups G₁₀₀, G₂₀₀, and G₃₀₀, respectively. The current path controllers S₁₀₀, S₂₀₀, and S₃₀₀ control a current path of the constant current I provided by the constant-current providing unit I₁₀₀ in accordance with current path control signals, such as pulse signals PWM₁₀₀, PWM₂₀₀, and PWM₃₀₀, respectively, provided by the current path control signal providing unit P₁₀₀.

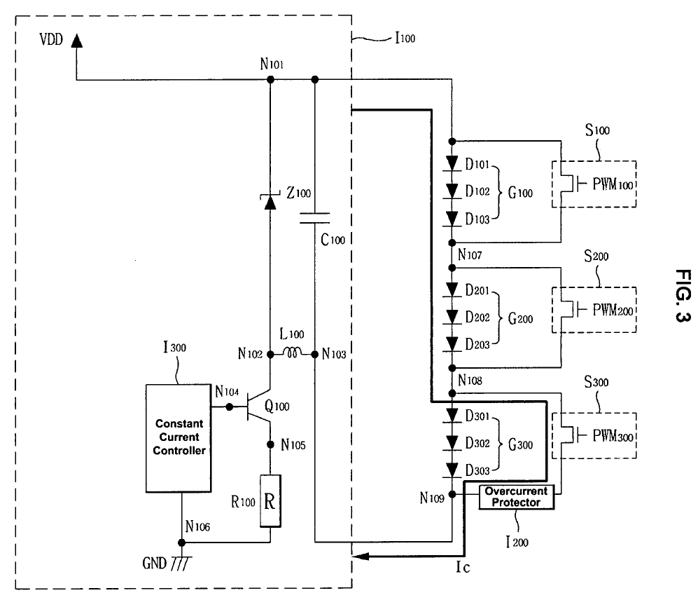

FIG. 3 is a circuit diagram of an exemplary device for driving a plurality of LEDs as a light source in a backlight of an LCD device according to an embodiment of the present invention. Referring to FIG. 3, the constant-current providing unit I₁₀₀ includes a constant current controller I₃₀₀, a voltage drop circuit, and a resistor R₁₀₀. The voltage drop circuit drops a power source voltage VDD to a predetermined voltage. The voltage drop circuit may be, for example, a buck type voltage drop circuit.

The buck type voltage drop circuit may include a switching element Q₁₀₀, an inductor L₁₀₀, and a capacitor C₁₀₀. The switching element Q₁₀₀ may include a metal oxide semiconductor field effect transistor (MOSFET) or a bipolar junction transistor (BJT). A Zener diode Z₁₀₀ is connected between a first node N₁₀₁, and a second node N₁₀₂. The inductor L₁₀₀ is connected between the second node N₁₀₂ and a third node N₁₀₃. The capacitor C₁₀₀ is connected between the first node N₁₀₁ and the third node N₁₀₃.

The constant current controller I₃₀₀ is connected between a fourth node N₁₀₄ and a sixth node N₁₀₆. The switching element Q₁₀₀ is connected between the second node N₁₀₂, the fourth node N₁₀₄, and a fifth node N₁₀₅. The resistor R₁₀₀ is connected between the fifth node N₁₀₅ and the sixth node N₁₀₆. The power source voltage VDD is applied to the first node N₁₀₁. The sixth node N₁₀₆ is connected to the ground GND.

The first LED group G₁₀₀ is connected between the first node N₁₀₁ and a seventh node N₁₀₇. The first current path controller S₁₀₀ is also connected between the first node N₁₀₁ and the seventh node N₁₀₇ in parallel with the first LED group G₁₀₀. The second LED group G₂₀₀ is connected between the seventh node N₁₀₇ and an eighth node N₁₀₈. The second current path controller S₂₀₀ is also connected between the seventh node N₁₀₇ and the eighth node N₁₀₈ in parallel with the second LED group G₂₀₀. The third LED group G₃₀₀ is connected between the eighth node N₁₀₈ and the third node N₁₀₃. The third current path controller S₃₀₀ is also connected between the eighth node N₁₀₈ and the third node N₁₀₃. in parallel with the third current path controller S₃₀₀.

The switching element Q₁₀₀ is activated or deactivated by a pulse signal provided by the constant current controller I₃₀₀. When the switching element Q₁₀₀ is activated, an electric energy is stored in the inductor L₁₀₀ or the capacitor C₁₀₀. When the switching element Q₁₀₀ is deactivated, the energy stored in the inductor L₁₀₀ and the capacitor C₁₀₀ is emitted to one or more of the LED groups G₁₀₀, G₂₀₀, and G₃₀₀.

The Zener diode Z₁₀₀ suppresses a supply of over-voltage to the switching element Q₁₀₀. The resistor R₁₀₀ controls a magnitude of an electric current flowing through the switching element Q₁₀₀. The constant current controller I₃₀₀ controls a duty ratio of the pulse signal or a frequency of the pulse signal provided to the switching element Q₁₀₀. Thus, the buck type voltage drop circuit drops the power source voltage VDD to a predetermined voltage. For example, the buck type voltage drop circuit may drop the provided power source voltage VDD from about 24 volts to about 6 volts to 18 volts to power one or more of the LED groups G₁₀₀, G₂₀₀, and G₃₀₀.

The first current path controller S₁₀₀ controls the current path of the constant current I provided to the first LED group G₁₀₀. The second current path controller S₂₀₀ controls the current path of the constant current I provided to the second LED group G₂₀₀. The third current path controller S₃₀₀ controls the current path of the constant current I that is provided by the constant-current providing unit I₁₀₀ to the second LED group G₂₀₀. The current path controllers S₁₀₀, S₂₀₀, and S₃₀₀ may include metal oxide semiconductor field effect transistors (MOSFET) or bipolar junction transistors (BJT). For example, as shown in FIG. 3, the current path controllers S₁₀₀, S₂₀₀, and S₃₀₀ may include n-type metal oxide semiconductor field effect transistors (nMOSFET).

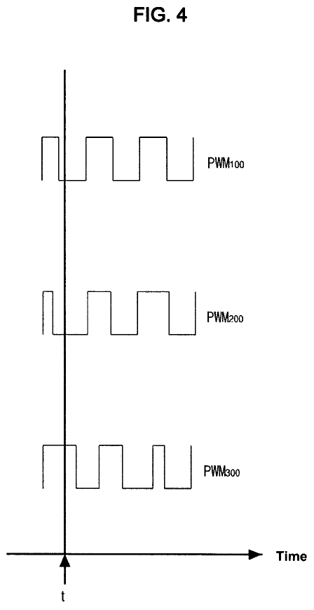

FIG. 4 is a graphical illustration of exemplary current path control signals for controlling the driving of LEDs of FIGS. 2 and 3 according to an embodiment of the present invention. Referring to FIGS. 3 and 4, the first current path control signal PWM₁₀₀ is applied to the first current path controller S₁₀₀, the second current path control signal PWM₂₀₀ to the second current path controller S₂₀₀, and the third current path control signal PWM₃₀₀ to the third current path controller S₃₀₀. For example, the first current path controller S₁₀₀ and the second current path controller S₂₀₀ are turned off and the third current path controller S₃₀₀ is turned on at a time t. Accordingly, as shown in FIG. 3, a current path Ic is formed from the constant-current providing unit I₁₀₀ through the first LED group G₁₀₀, the second LED group G₂₀₀, and the third current path controller S₃₀₀, bypassing the third LED group G₃₀₀. Hence, the constant current I is provided to the first LED group G₁₀₀ and the second LED group G₂₀₀, thereby turning on the LEDs D₁₀₁ to D₁₀₃ of the first LED group G₁₀₀, and the LEDs D₂₀₁ to D₂₀₃ of the second LED group G₂₀₀. However, the LEDs D₃₀₁ to D₃₀₃ of the third LED group G₃₀₀ are turned off because the third LED group G₃₀₀ is bypassed by the third current path controller S₃₀₀.

Thus, according to an embodiment of the present invention, one constant-current providing unit I₁₀₀ is enough to power the plurality of LED groups G₁₀₀, G₂₀₀, and G₃₀₀. The current path through individual ones of the of the LED groups G₁₀₀, G₂₀₀, and G₃₀₀ is controlled with the current path controller S₁₀₀, S₂₀₀, and S₃₀₀ which may bypass one or more of the LED groups G₁₀₀, G₂₀₀, and G₃₀₀.

In an embodiment of the present invention, the number n of the LEDs D₁₀₁ to D₁₀₃, D₂₀₁ to D₂₀₃, and D₃₀₁ to D₃₀₃ in the respective LED groups G₁₀₀, G₂₀₀, and G₃₀₀ may be within a range of about 2 to about 15. The number n may be chosen in accordance with a desired voltage to be applied to the respective current path controllers S₁₀₀, S₂₀₀, and S₃₀₀. The voltage applied to a particular one of the current path controllers S₁₀₀, S₂₀₀, and S₃₀₀ increases with the number of LEDs in the particular one of the path controllers S₁₀₀, S₂₀₀, and S₃₀₀.

Referring back to FIG. 3, the third current path controller S₃₀₀ can further include an over-current protector I₂₀₀. The over-current protector I₂₀₀ can limit the current flowing through the current path controllers S₁₀₀, S₂₀₀, and S₃₀₀ to avoid a flow of over-current The over-current protector I₂₀₀ may include a Zener diode or a resistor.

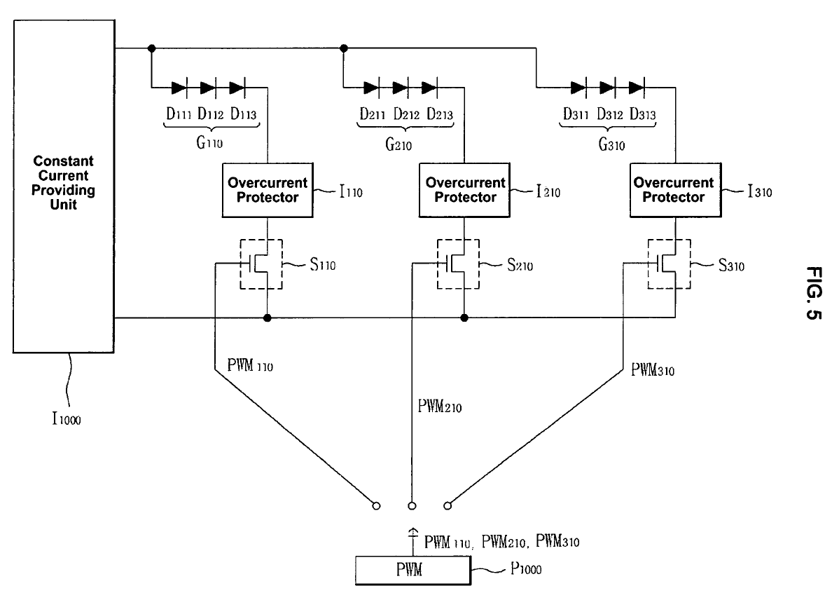

FIG. 5 is a schematic diagram of an exemplary device for driving a plurality of LEDs as a light source in a backlight of an LCD device according to another embodiment of the present invention. Referring to FIG. 5, the device for driving the LED includes LED groups G₁₁₀, G₂₁₀, and G₃₁₀, a constant-current providing unit I₁₀₀₀, group activating units S₁₁₀, S₂₁₀, and S₃₁₀, and a group activation signal providing unit P₁₀₀₀. The LED groups G₁₁₀, G₂₁₀, and G₃₁₀ have a plurality k of LEDs D₁₁₁ to D₁₁₃, D₂₁₁ to D₂₁₃, and D₃₁₁ to D₃₁₃ connected in series. The LED groups G₁₁₀, G₂₁₀, and G₃₁₀ are connected in parallel with each other.

The constant-current providing unit I₁₀₀₀ provides a constant current to the LED groups G₁₁₀, G₂₁₀, and G₃₁₀. The group activating units S₁₁₀, S₂₁₀, and S₃₁₀ are connected in series with the LED groups G₁₁₀, G₂₁₀, and G₃₁₀, respectively, and activate the LED groups G₁₁₀, G₂₁₀, and G₃₁₀, respectively.

The group activation signal providing unit P₁₀₀₀ provides group activation signals, such as pulse signals PWM₁₁₀, PWM₂₁₀, and PWM₃₁₀, to the group activating units S₁₁₀, S₂₁₀, and S₃₁₀, respectively. The group activation signal providing unit P₁₀₀₀ can sequentially provide the group activation signals PWM₁₁₀, PWM₂₁₀, and PWM₃₁₀ for a predetermined time. For example, when the device for driving the LED is driven at a frequency of about 60 Hz, the group activation signal providing unit P₁₀₀₀ can sequentially provide the group activation signals PWM₁₁₀, PWM₂₁₀, and PWM₃₁₀ each for about 1/60 seconds 16.7 msec.

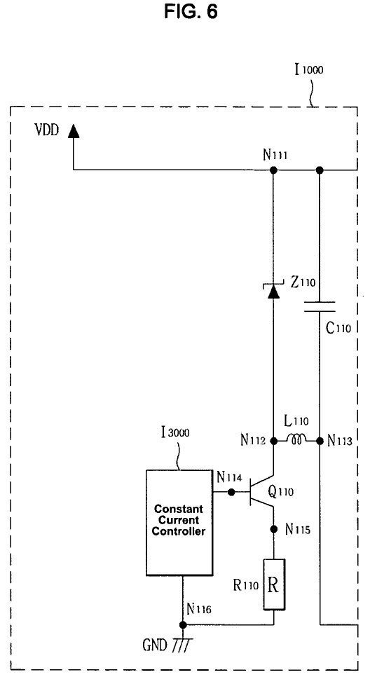

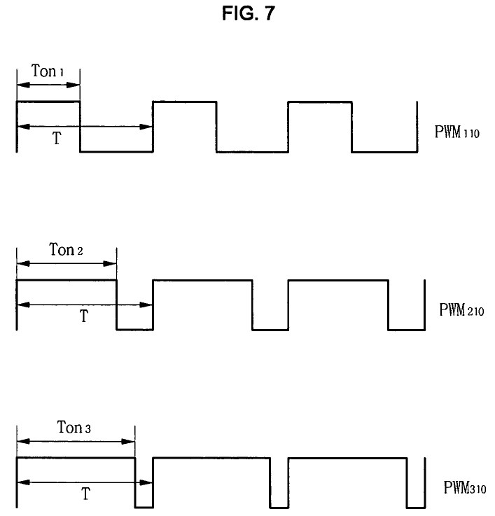

FIG. 6 is a circuit diagram of an exemplary constant-current providing unit for the device for driving a plurality of LEDs of FIG. 5. FIG. 7 is a graphical illustration of exemplary group activation signals in a device for driving a light emitting diode according to anther embodiment of the present invention. Referring to FIG. 6, the constant-current providing unit I₁₀₀₀ includes a constant current controller I₃₀₀₀, a voltage drop circuit, and a resistor R₁₁₀. The voltage drop circuit drops a power source voltage VDD to a predetermined voltage. As described above, a buck type voltage drop circuit may be used. For example, the buck type voltage drop circuit may include a switching element Q₁₀₀, an inductor L₁₀₀, and a capacitor C₁₀₀. The switching element Q₁₀₀ may include a metal oxide semiconductor field effect transistor MOSFET or a bipolar junction transistor BJT.

A Zener diode Z₁₀₀ is connected between a first node N₁₁₁ and a second node N₁₁₂. An inductor L₁₁₀ is connected between the second node N₁₁₂ and a third node N₁₁₃. A capacitor C₁₁₀ is connected between the first node N₁₁₁ and the third node N₁₁₃. The constant current controller I₃₀₀₀ is connected between a fourth node N₁₁₄ and a sixth node N₁₁₆. The switching element Q₁₁₀ is connected between the second node N₁₁₂, the fourth node N₁₁₄, and a fifth node N₁₁₅. The resistor R₁₁₀ is connected between the fifth node N₁₁₅ and the sixth node N₁₁₆.

The first LED group G₁₁₀ and the first group activating unit S₁₁₀ are connected between the first node N₁₁₁ and the third node N₁₁₃. The second LED group G₂₁₀ and the second group activating unit S₂₁₀ are connected in parallel with the first LED group G₁₁₀ and the first group activating unit S₁₁₀. The third LED group G₃₁₀ and the third group activating unit S₃₁₀ are connected in parallel with the first LED group G₁₁₀ and the first group activating unit S₁₁₀. The power source voltage VDD is applied to the first node N₁₁₁. The sixth node N₁₁₆ is connected the ground GND.

The switching element Q₁₁₀ is activated or deactivated by a pulse signal provided by the constant current controller I₃₀₀₀. When the switching element Q₁₁₀ is activated, an electric energy is stored in the inductor L₁₁₀ or the capacitor C₁₁₀. When the switching element Q₁₁₀ is deactivated, the energy stored in the inductor L₁₁₀ and the capacitor C₁₁₀ is emitted to the LED groups G₁₁₀, G₂₁₀, and G₃₁₀.

The Zener diode Z₁₁₀ prevents a supply of an excessive voltage to the switching element Q₁₁₀. The resistor R₁₁₀ controls a magnitude of an electric current flowing through the switching element Q₁₁₀. The constant current controller I₃₀₀₀ controls a duty ratio of the pulse signal or a frequency of the pulse signal provided to the switching element Q₁₁₀. Thus, the buck type voltage drop circuit drops the power source voltage VDD to a predetermined voltage. For example, when the device for driving the LED is used for a backlight for a liquid crystal display, the power source voltage VDD of about 24 volts is provided and dropped to a voltage of about 6 volts to 18 volts using the buck type voltage drop circuit, and is provided to the LED groups G₁₁₀, G₂₁₀, and G₃₁₀.

The first group activating unit S₁₁₀ may be activated by the first group activation signal PWM₁₁₀ and provides the constant current received from the constant-current providing unit I₁₀₀₀ to the first LED group G₁₁₀, thereby activating the first LED group G₁₁₀. Next, the second group activating unit S₂₁₀ may be activated by a second group activation signal PWM₂₁₀ and provides the constant current received from the constant-current providing unit I₁₀₀₀ to the second LED group G₂₁₀, thereby activating the second LED group G210. Next, the third group activating unit S₃₁₀ may be activated by the third group activation signal PWM₃₁₀ and provides the constant current received from the constant-current providing unit I₁₀₀₀ to the third LED group G₃₁₀, thereby activating the third LED group G₃₁₀.

The group activating units S₁₁₀, S₂₁₀, and S₃₁₀ may be switches, for example metal oxide semiconductor field effect transistors (MOSFET) or bipolar junction transistors (BJT). For example, as shown in FIG. 5, the group activating units S₁₁₀, S₂₁₀, and S₃₁₀ may include n-type metal oxide semiconductor field effect transistors (nMOSFET).

The first group activation signal PWM₁₁₀ is applied to the first group activating unit S₁₁₀, the second group activation signal PWM₂₁₀ to the second group activating unit S₂₁₀, and the third group activation signal PWM₃₁₀ to the third group activating unit S₃₁₀ as shown in FIG. 7. For example, the group activating units are activated and the LED groups are activated during time periods Ton₁, Ton₂, and Ton₃ for sustaining the group activation signals PWM₁₁₀, PWM₂₁₀, and PWM₃₁₀ in high states.

Simply, each of activation times of the LED groups G₁₁₀, G₂₁₀, and G₃₁₀ can be controlled in proportion to each of the duty ratios Ton₁/T, Ton₂/T, and Ton₃/T of the group activation signals PWM₁₁₀, PWM₂₁₀, and PWM₃₁₀. As shown in FIG. 7, when the duty ratio Ton₁/T of the first group activation signal PWM₁₁₀ is the shortest, and the duty ratio Ton₃/T of the third group activation signal PWM₃₁₀ is the longest, the activation time of the first LED group G₁₁₀ is the shortest, and the activation time of the third LED group G₃₁₀ is the longest. Accordingly, each of the LED groups G₁₁₀, G₂₁₀, and G₃₁₀ can be independently controlled in luminance. Therefore, in the case of the use for the backlight for the liquid crystal display, the luminance can be locally controlled.

According to an embodiment of the present invention, the device for driving the LED can control the activation times of the respective LED groups G₁₁₀, G₂₁₀, and G₃₁₀, using the group activating units S₁₁₀, S₂₁₀, and S₃₁₀ for the respective LED groups G₁₁₀, G₂₁₀, and G₃₁₀. Thus, the luminance of the respective LED groups G₁₁₀, G₂₁₀, and G₃₁₀ can be independently controlled even while using only one constant-current providing unit I₁₀₀₀.

The number n of the LEDs D₁₁₁ to D₁₁₃, D₂₁₁ to D₂₁₃, and D₃₁₁ to D₃₁₃ in respective LED groups G₁₁₀, G₂₁₀, and G₃₁₀ maybe within a range of about 2 to about 15. The number n may be chosen in accordance with a desired voltage to be applied to the respective group activating units S₁₁₀, S₂₁₀, and S₃₁₀. The voltage applied to a particular one of the group activating units S₁₁₀, S₂₁₀, and S₃₁₀ increases with the number of LEDs in the particular one of the group activating units S₁₁₀, S₂₁₀, and S₃₁₀.

Referring back to FIG. 5, over-current protectors I₁₁₀, I₂₁₀, and I₃₁₀ may be further provided between the LED groups G₁₁₀, G₂₁₀, and G₃₁₀ and the group activating units S₁₁₀, S₂₁₀, and S₃₁₀, respectively. Thus, the over-current protectors I₁₁₀, I₂₁₀, and I₃₁₀ can prevent a flow of over-current through the group activating units S₁₁₀, S₂₁₀, and S₃₁₀. The over-current protectors I₁₁₀, I₂₁₀, and I₃₁₀ may include Zener diodes or resistors.

As described above, in the device for driving the LED according to the present invention, in the case of the use for a backlight of a flat panel display, e.g., the liquid crystal display, the plurality of the LEDs can be divided into a plurality of groups and driven using one constant-current providing circuit, thereby simplifying its circuit construction, and reducing its cost.

Thus, according to an embodiment of the present invention, one constant-current providing unit is enough to power the plurality of LED groups. The device for driving the LED can control the activation times of the respective LED groups using group activating units corresponding to the respective LED groups. Thus, the luminance of the respective LED groups can be independently controlled even while using only one constant-current providing unit.

It will be apparent to those skilled in the art that various modifications and variations can be made in the exemplary embodiments the processing apparatus of the present invention. Thus, it is intended that embodiments of the present invention cover the modifications and variations of the embodiments described herein provided they come within the scope of the appended claims and their equivalents.

What is claimed is:

1. A device for driving a plurality of light emitting diodes, comprising:
a plurality of light emitting diode groups in series;
a current providing unit for providing a current to the plurality of light emitting diode groups;
at least one current path controller in parallel with a corresponding one of the light emitting diode groups for turning off the corresponding one of the light emitting diode groups in accordance with a control signal.

2. The device of claim 1, wherein the at least one current path controller includes a metal oxide semiconductor field effect transistor or a bipolar junction transistor.

4. The device of claim 1, further comprising an over-current protector for suppressing a flow of over current through the at least one current path controller.

5. The device of claim 4, wherein the over-current protector includes one of a Zener diode and a resistor.

6. The device of claim 1, wherein the number of the light emitting diodes in at least one of the emitting diode groups is in a range of about 2 to about 15.

7. The device of claim 1, wherein the control signal includes a pulse signal.

8. The device of claim 1, wherein the current from the current providing unit is substantially constant.

9. A backlight unit, including the device of claim 1.

10. An LCD device, including the device of claim 1.

11. A device for driving a plurality of light emitting diodes in an LCD device, comprising:
a plurality of light emitting diode groups in parallel;
a current providing unit for providing a current to the plurality of light emitting diode groups;
at least one switch in series with a corresponding one of the light emitting diode groups for activating the corresponding one of the light emitting diode groups in accordance with a control signal.

12. The device of claim 11, wherein the number of the light emitting diodes in at least one of the emitting diode groups is in a range of about 2 to about 15.

13. The device of claim 11, wherein the at least one switch includes a metal oxide semiconductor field effect transistor or a bipolar junction transistor.

14. The device of claim 11, wherein an activation time of the corresponding one of the light emitting diode groups is proportional to a duty ratio of the control signal.

15. The device of claim 11, further comprising an over-current protector in series with the at least one switch and the corresponding one of the light emitting diode groups for preventing a flow of over-current through the corresponding one of the group activating units.

16. A backlight unit, including the device of claim 11.

17. An LCD device, including the device of claim 11.

18. A device for driving a plurality of light emitting diodes in an LCD device, comprising:
a plurality light emitting diode groups in parallel;
a current providing unit for providing a current to the light emitting diode groups;
a plurality of switches, each of which in series with a corresponding one of the light emitting diode groups for activating the corresponding one of the light emitting diode groups in accordance with a corresponding control signal.

19. The device of claim 18, wherein an activation time of the corresponding one of the light emitting diode groups is proportional to a duty ratio of the control signal.

20. The device of claim 18, wherein the switches sequentially activating the corresponding ones of the plurality of light emitting diodes.

21. A backlight unit, including the device of claim 18.

22. An LCD device, including the device of claim 18.
